(19) United States
(12) Patent Application Publication
(10) Pub. No.: US 2026/0106686 A1
(43) Pub. Date: Apr. 16, 2026

(54) PREAMBLE DURATION CONTROL OF A PHYSICAL LAYER PROTOCOL DATA UNIT IN WIRELESS COMMUNICATION

(71) Applicant: MEDIATEK INC., Hsinchu City (TW)

(72) Inventor: Chi-Han Huang, Hsinchu City (TW)

(73) Assignee: MEDIATEK INC., Hsinchu City (TW)

(21) Appl. No.: 18/915,259

(22) Filed: Oct. 14, 2024

(51) Int. Cl. H04L 1/00

(52) U.S. Cl. CPC H04L 1/0004; H04L 1/0007

(57) ABSTRACT

The present invention provides a control method of a wireless communication module, wherein the control method includes the steps of: starting to enter a normal state from a low-power state; obtaining a plurality of MPDUs; generating a preamble and extending a length of the preamble by adding unnecessary or redundant information to the preamble, or by adjusting a rate of the preamble; and generating a PPDU by using the preamble and the plurality of MPDUs.

### BACKGROUND

In order to lower the power consumption when a wireless communication module does not need to transmit packets, a PCIe (Peripheral Component Interconnect Express) interface enters a low power state, such as L1.2 state, to disable part of the circuits such as a phase-locked loop, transmitter and receiver. Then, when the wireless communication module needs to transmit packets, the PCIe interface will be waked up and resume to a normal state, such as L0 state, to allow the wireless communication module to get the data to generate a PPDU (Physical Layer Protocol Data Unit) to be transmitted. However, because entering the L0 state from the L1.2 state requires a long wake-up time, the wireless communication module needs to add a lot of dummy delimiters to the payload during the process of generating and transmitting PPDU if an under-run issue occurs, thus reducing efficiency. In addition, because the wireless communication module generally uses higher bandwidth, higher number of spatial streams (NSS) or higher modulation and coding scheme (MCS), adding extra dummy delimiters in the payload of the PPDU means that the wireless communication module needs to use higher power consumption to transmit dummy data.

### SUMMARY

It is therefore an objective of the present invention to provide a wireless communication method, which can intentionally extend the length of the preamble of the PPDU when the wireless communication module enters a normal state from a low-power state, to solve the above-mentioned problems.

According to one embodiment of the present invention, a control method of a wireless communication module comprises the steps of: starting to enter a normal state from a low-power state; obtaining a plurality of MPDUs; generating a preamble and extending a length of the preamble by adding unnecessary or redundant information to the preamble, or by adjusting a rate of the preamble; and generating a PPDU by using the preamble and the plurality of MPDUs.

According to one embodiment of the present invention, a wireless communication module of an electronic device is configured to perform the steps of: starting to enter a normal state from a low-power state; obtaining a plurality of MPDUs; generating a preamble and extending a length of the preamble by adding unnecessary or redundant information to the preamble, or by adjusting a rate of the preamble; and generating a PPDU by using the preamble and the plurality of MPDUs.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to one embodiment of the present invention.

FIG. 2 is a flowchart of control method of a wireless communication module according to one embodiment of the present invention.

FIG. 3 shows a PPDU structure.

FIG. 4 is a diagram illustrating an operation of the wireless communication module according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . ”. The terms “couple” and “couples” are intended to mean either an indirect or a direct electrical connection. Thus, if a first device couples to a second device, that connection may be through a direct electrical connection, or through an indirect electrical connection via other devices and connections.

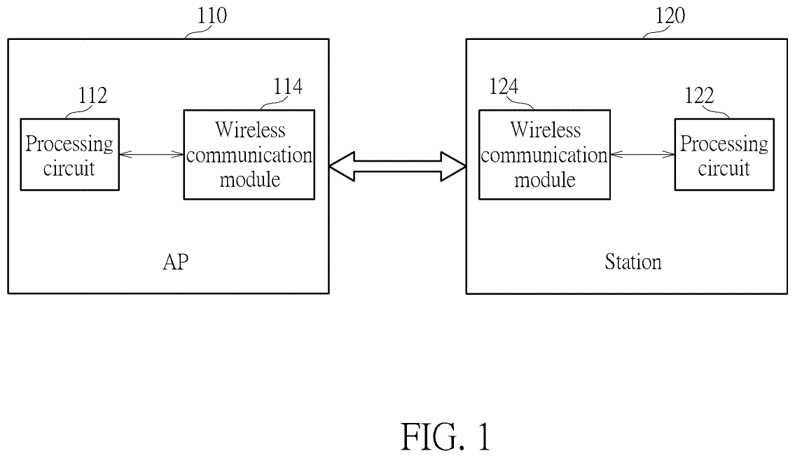

FIG. 1 is a diagram illustrating a wireless communication system according to one embodiment of the present invention. As shown in FIG. 1, the wireless communication system comprises an access point (AP) 110 and at least one station such as 120. The AP 110 is a Wi-Fi access point that allows other wireless devices such as the station 120 to connect to a wired network, and the AP 110 mainly comprises a processing circuit 112 and a wireless communication module 114. The station 120 is a Wi-Fi station comprising a processing circuit 122 and a wireless communication module 124, and the station 120 can be a cell phone, a tablet, a notebook, or any other electronic device capable of wirelessly communicating with the AP 110. In addition, the wireless communication module 114/124 comprises at least a media address control (MAC) layer circuitry and a physical layer circuitry.

In this embodiment, the AP 110 and the station 120 are multi-link devices (MLD), that is the AP 110 and the station 120 are communicated with each other by using two or more links. In this embodiment, each one of the two or more links may use a channel corresponding to a 2.4 GHz band (e.g., 2.412 GHz-2.484GHz), a 5 GHz band (e.g., 4.915 GHz-5.825 GHz) or a 6 GHz band (e.g., 5.925 GHz-7.125 GHz).

The wireless communication module 114 can selectively operate in a normal mode or a power-saving mode (sleep mode). In this embodiment, the wireless communication module 114 has PCIe related circuits, and the wireless communication module 114 selectively operates in a normal/active state (e.g., L0 state) or a low-power state (e.g., L1.2 state) defined in the PCIe specifications. Specifically, when the wireless communication module 114 does not need to transmit packets, the wireless communication module 114 enters the low-power state to disable part of the circuits such as a phase-locked loop, transmitter and receiver; and when the wireless communication module 114 needs to transmit packets, a wake-up mechanism is triggered so that the wireless communication module 114 enters the normal state from the low-power state to get the data to generate a PPDU to be transmitted. As described in the background of the present invention, entering the L0 state from the L1.2 state requires a long wake-up time, and the conventional wireless communication module needs to add a lot of dummy delimiters to the payload during the process of generating and transmitting PPDU if an under-run issue occurs, so that the conventional wireless communication module needs to use higher power consumption to transmit dummy data. Therefore, the following embodiments provide control methods of the wireless communication module 114 to solve these conventional problems.

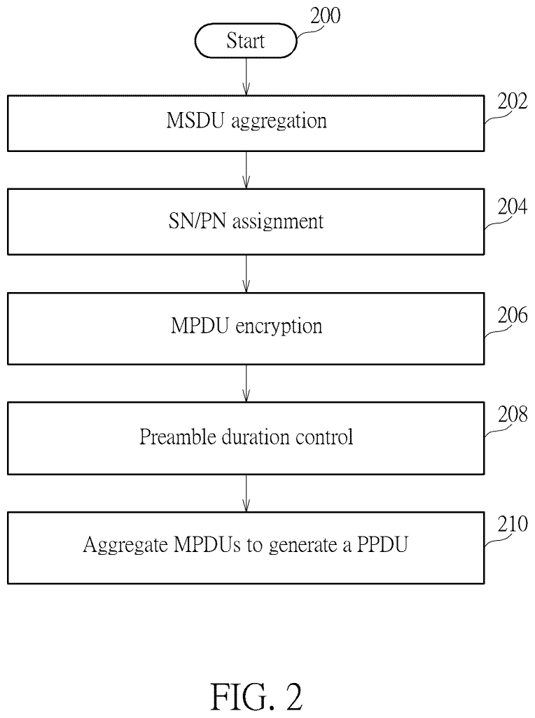

FIG. 2 is a flowchart a control method of one of the wireless communication modules 114 and 124 according to one embodiment of the present invention. In the following description, the wireless communication module 114 serves as an example to perform the following steps, but the present invention is not limited thereto. In Step 200, the flow starts, and the AP 110 and the station 120 have established one or more links before, and the AP 110 has just been awakened. For example, the AP 110 starts to enter the low-power state from the normal mode, and at this time, the wireless communication module 114 has not yet been fully awakened. In Step 202, the wireless communication module 114 obtains a plurality of MAC service data units (MSDUs), and the wireless communication module 114 aggregates the MSDUs to generate MPDUs, wherein one MPDU may comprise one or more MSDUs. In Step 204, the wireless communication module 114 performs sequence number (SN) and packet number (PN) assignment for each MPDU. In Step 206, an encryption operation is performed on the MPDUs. In Step 208, the MAC layer circuit within the wireless communication module 114 performs a preamble duration control, to intentionally extend the length of the preamble for the PPDU generated in the next step. In Step 210, the MAC layer circuit within the wireless communication module 114 aggregates a plurality of MPDUs to generate a PPDU, and the PPDU is transmitted to the station 120 via a physical layer circuit of the wireless communication module 114. It is noted that Steps 202-206 and Step 210 are known by a person skilled in the art, and the present invention focuses on the preamble duration control of Step 208, so the detailed operations of Steps 202-206 and Step 210 are omitted here.

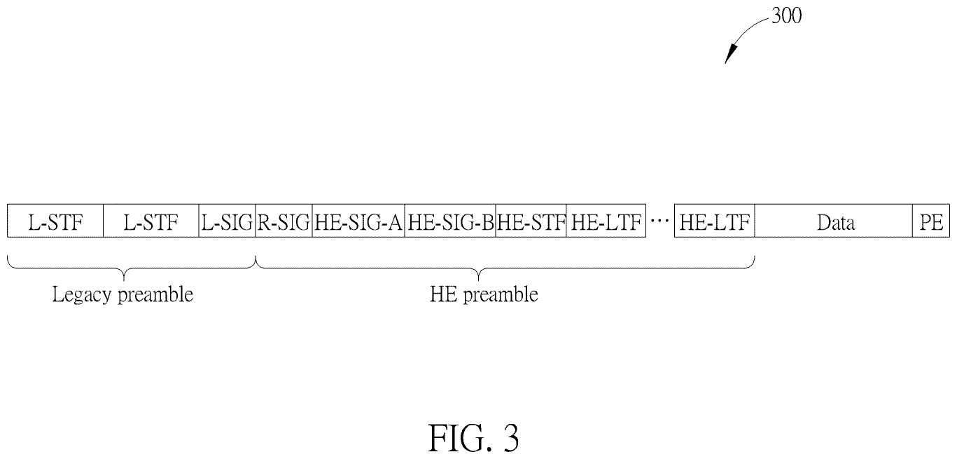

Regarding the preamble duration control of Step 208, the wireless communication module 114 can extend the length of the preamble of the PPDU by adding some unnecessary or redundant information to the preamble. FIG. 3 shows a high efficiency (HE) PPDU 300 defined in IEEE 802.11ax, the HE PPDU comprises a legacy preamble, a HE preamble, a data field and packet extension (PE), wherein the legacy preamble comprises a L-STF field, a L-LTF field and a L-SIG field, and the HE preamble comprises a RL-SIG field, a HE-SIG-A field, an optional HE-SIG-B field, a HE-STF field and a plurality of HE-LTF field. In this embodiment, the wireless communication module 114 can extend the length of the preamble by controlling the contents of the HE-SIG-B field and/or the HE-LTF field.

The HE-SIG-B field comprises the resource unit allocation information for the stations communicated with the AP 110, and the HE-SIG-B field can use up to 16 symbols to record this information. In order to extend the length of the preamble, the wireless communication module 114 can intentionally control the HE-SIG-B field so that it has a higher number of symbols than the number of symbols sufficient for the HE-SIG-B field to record all the resource unit allocation information. In one embodiment, the wireless communication module 114 can intentionally control the HE-SIG-B field to have the maximum number of symbols allowed (i.e., 16 symbols), even if a few of symbols (i.e., less than 16 symbols) is enough to record all the resource unit allocation information. In addition, for these additional symbols that do not need to be used to record the resource unit allocation information, the wireless communication module 114 can fill these symbols by padding.

In one embodiment, the wireless communication module 114 can set a Dual Carrier Modulation (DCM) indication bit in the HE-SIG-A field to indicate that the DCM is applied for one or more fields of the preamble, such as the HE-SIG-B field, wherein the DCM can introduce frequency diversity into OFDM systems by transmitting the same information on two subcarriers separated in frequency. By adding the DCM indication bit indicating the DCM is applied, the length of the preamble can be extended.

In one embodiment, the wireless communication module 114 can pad the reserved STA_ID field within the HE-SIG-B field, to extend the length of the preamble.

In one embodiment, the wireless communication module 114 can set a MCS in the HE-SIG-A field to indicate the MCS applied for one or more fields of the preamble, such as the HE-SIG-B, so that the wireless communication module 114 can select lower MCS for the HE-SIG-B symbols, to extend the length of the preamble.

The HE-LTF field comprises a plurality of HE-LTF symbols for channel estimation, and the HE physical layer provides support for 3.2 us (1×), 6.4 us (2×) and 12.8 us (4×) HE-LTF symbol durations. In this embodiment, the wireless communication module 114 can intentionally control the HE-LTF field so that it has a higher number of symbols than the number of symbols sufficient for the channel estimation. In one embodiment, the wireless communication module 114 can intentionally control the HE-LTF field to have the maximum number of symbols allowed. In addition, the wireless communication module 114 may set the HE-LTF field to support maximum HE-LTF symbol durations (e.g., 12.8 us (4×)) with a maximum guard interval.

In addition, the above embodiments for extending the length of the preamble can be combined with each other. For example, at least a portion of the above-mentioned the number of HE-SIG-B symbol control, the DCM control, padding the reserved STA_ID field, the HE-SIG-B-MCS, and the number of HE-SIG-B symbol control can be used to extend the length of the preamble.

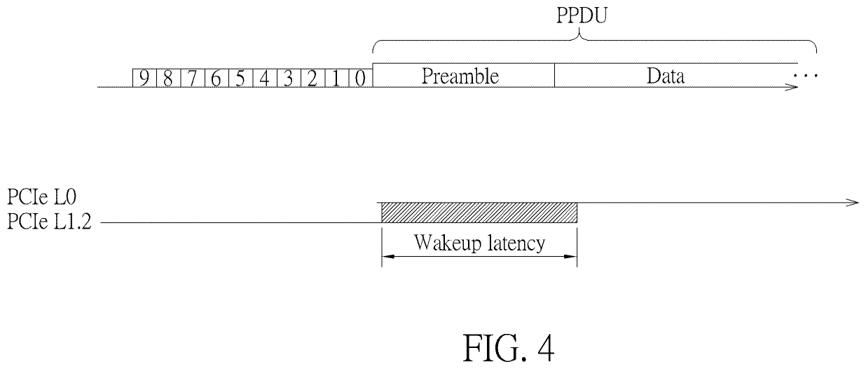

FIG. 4 is a diagram illustrating an operation of the wireless communication module according to one embodiment of the present invention. In the example shown in FIG. 4, the wireless communication module 114 performs a back-off operation to start the transmission of the PPDU, and the Enhanced Distributed Channel Access Function (EDCAF) is determined and start MPDU aggregation; and a Clear Channel Assessment (CCA) is checked and the MAC layer to physical layer transmission is raised. Referring to FIG. 4, by intentionally extending the preamble of the PPDU, all or most of the data field in the PPDU can be transmitted when the PCIe is fully awakened, so the PPDU does not need to add any dummy delimiter in the data field, or only need to add a few dummy delimiters in the data field. In addition, because the HE-SIG-B field of the preamble is transmitted with low modulation and coding scheme (MCS) and one spatial stream (1SS), and the data filed of the PPDU is generally transmitted with higher MCS and/or two or more spatial streams, the power consumption increased by extending the preamble will be much smaller than the power consumption increased by adding the dummy delimiters in the data field. In addition, adding more HE-LTF symbols in the HE-LTF field for channel estimation can improve the receiver sensitivity without increasing power consumption too much.

In one embodiment, the above preamble duration control mechanism is only performed for the generation of the first PPDU when the wireless communication module 114 just enters the normal state from the low-power state. That is, the second PPDU generated immediately after the first PDDU shown in FIG. 4 does not use the above-mentioned preamble control mechanism, or use only part of the above-mentioned preamble control mechanism. In a first example, the wireless communication module 114 extends the preamble of the first PPDU by controlling the HE-SIG-B field to have the maximum number of symbols allowed, and the wireless communication module 114 does not intentionally extend the preamble of the second PPDU so that the HE-SIG-B field only includes the number of symbols sufficient to record all the resource unit allocation information (i.e., the number of the symbols in the HE-SIG-B field of the second PPDU may be less than the maximum number of symbols allowed). In a second example, the wireless communication module 114 controls the HE-SIG-B field of the preamble of the first PPDU to comprise the DCM indication bit indicating that the DCM is applied for one or more fields of the preamble, and the wireless communication module 114 controls the HE-SIG-B field of the preamble of the second PPDU to comprise the DCM indication bit indicating that the DCM is not applied for one or more fields of the preamble. In a third example, the wireless communication module 114 controls the HE-LTF field of the preamble of the first PPDU to have the maximum number of symbols allowed, but the wireless communication module 114 does not control the HE-LTF field of the preamble of the second PPDU to have the maximum number of symbols allowed (i.e., the symbol number of the HE-LTF field of the second PPDU may be less than the maximum number of symbols allowed). In a fourth embodiment, the wireless communication module 114 controls the HE-SIG-B symbols of the preamble of the first PPDU to correspond to first MCS, but the wireless communication module 114 controls the HE-SIG-B symbols of the preamble of the second PPDU to correspond to second MCS higher than the first MCS.

In is noted that the above embodiments use the HE PPDU 300 as an example, but this feature is not a limitation of the present invention. In other embodiment, the control method of the present invention can be applied to other types of PPDU such as extremely high-throughput (EHT) PPDU or ultra-high reliability (UHR) PPDU, and one or more fields of the preamble of this PPDU can be set to extend a length of the preamble of this PPDU. For example, a specific field of the preamble of the PPDU may have a maximum number of symbols allowed, or a specific field of the preamble of the PPDU may comprise the DCM indication bit indicating that the DCM is applied for one or more fields of the preamble, or a specific field of the preamble of the PPDU may be set to indicate that a lower MCS is applied for one or more fields of the preamble.

Briefly summarized, in the control method of the wireless communication module of the present invention, by intentionally extending the preamble of the PPDU, all or most of the data field in the PPDU can be transmitted when the PCIe is fully awakened, so the PPDU does not need to add any dummy delimiter in the data field, or only need to add a few dummy delimiters in the data field, to avoid the high power consumption problem caused by using higher data rate to transmit dummy delimiters in the prior art.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A control method of a wireless communication module, comprising:
starting to enter a normal state from a low-power state;
obtaining a plurality of media access control protocol data units (MPDUs);
generating a preamble and extending a length of the preamble by adding unnecessary or redundant information to the preamble, or by adjusting a rate of the preamble; and
generating a physical layer protocol data unit (PPDU) by using the preamble and the plurality of MPDUs.

2. The control method of claim 1, wherein the step of generating a preamble and extending the length of the preamble by adding unnecessary or redundant information to the preamble, or by adjusting the rate of the preamble comprises:
controlling a specific field of the preamble so that it has a higher number of symbols than a number of symbols sufficient for the specific field to record all resource unit allocation information.

3. The control method of claim 2, wherein the step of controlling the specific field of the preamble so that it has the higher number of symbols than the number of symbols sufficient for the specific field to record all the resource unit allocation information comprises:
intentionally controlling the specific field to have a maximum number of symbols allowed.

4. The control method of claim 2, wherein the specific field is a HE-SIG-A field or a HE-SIG-B field of the preamble.

5. The control method of claim 2, wherein the specific field is a HE-LTF field of the preamble.

6. The control method of claim 1, wherein the step of generating a preamble and extending the length of the preamble by adding unnecessary or redundant information to the preamble, or by adjusting the rate of the preamble comprises:
controlling a specific field to comprise a dual carrier modulation (DCM) indication bit indicating that the DCM is applied for one or more fields of the preamble.

7. The control method of claim 6, wherein the specific field is a HE-SIG-A field of the preamble.

8. The control method of claim 1, wherein the step of generating a preamble and extending the length of the preamble by adding unnecessary or redundant information to the preamble, or by adjusting the rate of the preamble comprises:
controlling a specific field to lower a modulation and coding scheme (MCS)setting of the preamble.

9. The control method of claim 8, wherein the specific field is a HE-SIG-A field of the preamble.

10. The control method of claim 1, wherein the PPDU is a first PPDU when the wireless communication module just enters the normal state from the low-power state.

11. The control method of claim 10, wherein the plurality of MPDUs are a plurality of first MPDUs, the preamble is a first preamble, and the control method further comprises:
obtaining a plurality of second MPDUs;
generating a second preamble without extending a length of the preamble by adding the unnecessary or redundant information, or generating the second preamble by using only part of the unnecessary or redundant information, or generating the second preamble without adjusting the rate of the preamble; and
generating a second PPDU by using the second preamble and the plurality of second MPDUs.

12. The control method of claim 11, wherein the second PPDU is generated immediately after the first PDDU.

13. The control method of claim 11, wherein the step of generating a preamble and extending the length of the preamble by adding unnecessary or redundant information to the preamble, or by adjusting the rate of the preamble comprises:
controlling a specific field of the preamble so that it has a higher number of symbols than a number of symbols sufficient for the specific field to record all resource unit allocation information; and
the step of generating the second preamble without extending the length of the preamble by adding the unnecessary or redundant information, or generating the second preamble by using only part of the unnecessary or redundant information comprises:
controlling the specific field of the second preamble so that the second preamble only comprises the number of symbols sufficient to record all the resource unit allocation information.

14. The control method of claim 13, wherein the specific field is a HE-SIG-A field or a HE-SIG-B field of the preamble.

15. A wireless communication module of an electronic device, configured to perform the steps of:
starting to enter a normal state from a low-power state;
obtaining a plurality of media access control protocol data units (MPDUs);
generating a preamble and extending a length of the preamble by adding unnecessary or redundant information to the preamble, or by adjusting a rate of the preamble; and
generating a physical layer protocol data unit (PPDU) by using the preamble and the plurality of MPDUs.

16. The wireless communication module of claim 15, wherein the step of generating a preamble and extending the length of the preamble by adding unnecessary or redundant information to the preamble comprises:
controlling a specific field of the preamble so that it has a higher number of symbols than a number of symbols sufficient for the specific field to record all resource unit allocation information.

17. The wireless communication module of claim 16, wherein the step of controlling the specific field of the preamble so that it has the higher number of symbols than the number of symbols sufficient for the specific field to record all the resource unit allocation information comprises:
intentionally controlling the specific field to have a maximum number of symbols allowed.

18. The wireless communication module of claim 16, wherein the specific field is a HE-SIG-A field or a HE-SIG-B field of the preamble.

19. The wireless communication module of claim 16, wherein the specific field is a HE-LTF field of the preamble.

20. The wireless communication module of claim 15, wherein the PPDU is a first PPDU when the wireless communication module just enters the normal state from the low-power state.
